(19) United States
(12) Patent Application Publication
(10) Pub. No.: US 2021/0082347 A1
(43) Pub. Date: Mar. 18, 2021

(54) PIXEL DRIVING CIRCUIT OF ACTIVE MATRIX ORGANIC LIGHT EMITTING DISPLAY DEVICE AND DRIVING METHOD OF ACTIVE MATRIX ORGANIC LIGHT EMITTING DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Bobiao CHANG, Shenzhen, Guangdong (CN); Yichien WEN, Shenzhen, Guangdong (CN)

(21) Appl. No.: 16/090,185

(22) PCT Filed: Sep. 7, 2018
(86) PCT No.: PCT/CN2018/104490

§ 371 Date: Sep. 28, 2018

(30) Foreign Application Priority Data
Mar. 29, 2018 (CN) 201810274329.5

(51) Int. Cl. G09G 3/3258; G09G 3/3266

(52) U.S. Cl. CPC G09G 3/3258; G09G 3/3266; G09G 2300/0866; G09G 2310/0202; G09G 2320/043; G09G 2300/0819

(57) ABSTRACT

Provided are a pixel driving circuit of an AMOLED device and a pixel driving method of an AMOLED device. The pixel driving circuit comprises: sub pixel circuits, scan lines, data lines and control lines. Each sub pixel circuit comprises a first TFT, a second TFT, a third TFT, a capacitor and an OLED. In a blank display stage of each frame of the AMOLED device, the plurality of rows of control lines respectively input corresponding control signals to control the third TFTs in at least one row of sub pixel circuits to be turned on, and the plurality of columns of data lines inputs bias voltages, wherein the bias voltages are smaller than the power source negative voltage so that an anode voltage of OLED in the sub pixel circuit, in which the third TFT is turned on, is smaller than a cathode voltage to achieve reverse bias.

### FIELD OF THE INVENTION

The present invention relates to a display field, and more particularly to a pixel driving circuit of an active matrix organic light emitting display device and a driving method of an active matrix organic light emitting display device.

### BACKGROUND OF THE INVENTION

The Organic Light Emitting Display (OLED) possesses many outstanding properties of self-illumination, low driving voltage, high luminescence efficiency, short response time, high clarity and contrast, near 180° view angle, wide range of working temperature, applicability of flexible display and large scale full color display. The OLED is considered as the most potential display device.

The OLED can be categorized into two major types according to the driving methods, which are the Passive Matrix OLED (PMOLED) and the Active Matrix OLED (AMOLED), i.e. two types of the direct addressing and the Thin Film Transistor (TFT) matrix addressing. The AMOLED comprises pixels arranged in array and belongs to active display type, which has high lighting efficiency and is generally utilized for the large scale display devices of high resolution.

The AMOLED is a current driving element. When the electrical current flows through the organic light emitting diode, the organic light emitting diode emits light, and the brightness is determined according to the current flowing through the organic light emitting diode itself. Most of the present Integrated Circuits (IC) only transmit voltage signals. Therefore, the AMOLED pixel driving circuit needs to accomplish the task of converting the voltage signals into the current signals. The traditional AMOLED pixel driving circuit generally is 2T1C, which is a structure comprising two thin film transistors and one capacitor to convert the voltage into the current.

As shown in FIG. 1, which is a 2T1C pixel driving circuit employed for AMOLED, comprising a first thin film transistor T10, a second thin film transistor T20, a capacitor C10 and an organic light emitting diode D10. The first thin film transistor T10 is a switch thin film transistor, and the second thin film transistor T20 is a drive thin film transistor, and the capacitor C10 is a storage capacitor. Specifically, a gate of the first thin film transistor T10 receives a scan signal Gate. A source of the first thin film transistor receives a data signal Data. A drain of the first thin film transistor is electrically coupled to a gate of the second thin film transistor T20 and one end of the capacitor C10. A source of the second thin film transistor T20 receives a power source positive voltage OVDD. A drain of the second thin film transistor is electrically coupled to an anode of the organic light emitting diode D10. A cathode of the organic light emitting diode D10 receives a power source negative voltage OVSS. The one end of the capacitor C10 is electrically coupled to the drain of the first thin film transistor T10, and the other end is electrically coupled to the source of the second thin film transistor T20. As displaying, the scan signal Gate controls the first thin film transistor T10 to be activated, and the data signal Data enters the gate of the second thin film transistor T20 and the capacitor C10 via the first thin film transistor T10. Then, the first thin film transistor T10 is deactivated. With the storage function of the capacitor C10, the gate voltage of the second thin film transistor T20 can remain to hold the data signal voltage to make the second thin film transistor T20 to be in the conducted state to drive the current to enter the organic light emitting diode D10 via the second thin film transistor T20 and to drive the organic light emitting diode D10 to emit light.

During operation of the pixel driving circuit shown in FIG. 1, the organic light emitting diode D10 is in a direct current bias state for a long time, and the internal ion polarity thereof forms a built-in electric field, which causes the threshold voltage of the organic light emitting diode D10 to continuously increase and makes the brightness gradually decrease. Meanwhile, the long time emission also shortens the life of the organic light emitting diode D10, and the problem of uniform image display caused by the different aging degrees of the organic light emitting diodes in different sub pixels may also occur to affect the display result.

### SUMMARY OF THE INVENTION

An objective of the present invention is to provide a pixel driving circuit of an active matrix organic light emitting display device, which can slow down the aging of organic light emitting diodes, extend the life of organic light emitting diodes and improve the display quality.

Another objective of the present invention is to provide a pixel driving method of an active matrix organic light emitting display device, which can slow down the aging of organic light emitting diodes, extend the life of organic light emitting diodes and improve the display quality.

For realizing the aforesaid objectives, the present invention first provides a pixel driving circuit of an active matrix organic light emitting display device, comprising: a plurality of sub pixel circuits arranged in an array, a plurality of rows of scan lines, a plurality of columns of data lines and a plurality of rows of control lines;

wherein each row of sub pixel circuits is correspondingly coupled to one row of scan lines and one row of control lines, and each column of sub pixel circuits is correspondingly coupled to one column of data lines.

each sub pixel circuit comprises a first thin film transistor, a second thin film transistor, a third thin film transistor, a capacitor and an organic light emitting diode; a gate of the first thin film transistor is electrically coupled to a corresponding scan line, a source of the first thin film transistor is electrically to a corresponding data line, and a drain of the first thin film transistor is electrically to a gate of the second thin film transistor; a source of the second thin film transistor receives a power source positive voltage, and a drain of the second thin film transistor is electrically to an anode of the organic light emitting diode; two ends of the capacitor are respectively coupled to the gate and the source of the second thin film transistor; a cathode of the organic light emitting diode receives a power source negative voltage; a gate of the third thin film transistor is electrically to a corresponding control line, a source of the third thin film transistor is electrically to a corresponding data line, and a drain of the third thin film transistor is electrically to the anode of the organic light emitting diode;

in a blank display stage of each frame of the active matrix organic light emitting display device, the plurality of rows of control lines respectively input corresponding control signals to control the third thin film transistors in at least one row of sub pixel circuits to be turned on, and the plurality of columns of data lines inputs bias voltages, wherein the bias voltages are smaller than the power source negative voltage.

The control signals inputted by the plurality of rows of control lines are pulse signals, and pulses of the control signals inputted by two adjacent control lines are sequentially generated, a phase difference between the pulses of the control signals inputted by the two adjacent control lines is one frame duration of the active matrix organic light emitting display device, a period of the control signal inputted by each control line is a product of the one frame duration of the active matrix organic light emitting display device and a number of rows of the sub pixel circuits.

in the blank display stage of each frame of the active matrix organic light emitting display device, the plurality of rows of control lines respectively input corresponding control signals to control the third thin film transistors in one row of sub pixel circuits to be turned on, and to control third thin film transistors in all sub pixel circuits except the row of sub pixel circuits to be turned off;

in an effective display stage of each frame of the active matrix organic light emitting display device, the plurality of rows of control lines respectively input corresponding control signals to control the third thin film transistors in all sub pixel circuits to be turned off.

In a blank display stage of a (m×M+n)th frame of the active matrix organic light emitting display device, the plurality of rows of control lines respectively input corresponding control signals to control the third thin film transistors in a nth row of sub pixel circuits to be turned on, and to control third thin film transistors in sub pixel circuits except the nth row of sub pixel circuits to be turned off, wherein M is a number of rows of the sub pixel circuits, m is a non-negative integer and n is a positive integer.

The third thin film transistor is an N-type thin film transistor.

In an effective display stage of each frame of the active matrix organic light emitting display device, the plurality of rows of scan lines sequentially input scan signals to control the first thin film transistors in the plurality of rows of sub pixel circuits to be sequentially turned on, and the plurality of columns of data lines input corresponding data signals for the active matrix organic light emitting display device to show images.

In the blank display stage of each frame of the active matrix organic light emitting display device, the plurality of rows of scan lines controls the first thin film transistors in all sub pixel circuits to be off.

The first thin film transistor is an N-type thin film transistor, and the second thin film transistor is a P-type thin film transistor.

The pixel driving circuit of the active matrix organic light emitting display device further comprises a control circuit electrically coupled to the plurality of rows of control lines, and the control signals inputted to the plurality of rows of control lines are provided by the control circuit.

The present invention further provides a pixel driving method of the active matrix organic light emitting display device, applied to the aforesaid pixel driving circuit of the active matrix organic light emitting display device, comprising:

Step S1, entering an effective display stage of a (m×M+n)th frame, wherein the plurality of rows of control lines inputs corresponding control signals to control the third thin film transistors in all sub pixel circuits to be turned off, and the plurality of rows of scan lines sequentially inputs scan signals to control the first thin film transistors in the plurality of rows of sub pixel circuits to be sequentially turned on, and the plurality of columns of data lines inputs the data signals corresponding to the (m×M+n)th frame for the active matrix organic light emitting display device to show the (m×M+n)th frame, wherein M is a number of rows of the sub pixel circuit, m is a non-negative integer and n is a positive integer;

Step S2, entering a blank display stage of the (m×M+n)th frame, wherein the plurality of rows of scan lines controls the first thin film transistors in all sub pixel circuits to be turned off, and an nth row of control lines inputs corresponding control signals to control the third thin film transistors in an nth row of sub pixel circuits to be turned on, and the control lines except the nth row of control lines input corresponding control signals to control the third thin film transistors in the sub pixel circuits except the nth row of sub pixel circuits to be turned off, and the plurality of columns of data lines inputs the bias voltages;

Step S3, entering an effective display stage of a (m×M+n+1)th frame, wherein the plurality of rows of control lines inputs corresponding control signals to control the third thin film transistors in all sub pixel circuits to be turned off, and the plurality of rows of scan lines sequentially inputs scan signals to control the first thin film transistors in the plurality of rows of sub pixel circuits to be sequentially turned on, and the plurality of columns of data lines inputs the data signals corresponding to the (m×M+n+1)th frame for the active matrix organic light emitting display device to show the (m×M+n+1)th frame;

Step S4, entering a blank display stage of the (m×M+n+1)th frame, wherein the plurality of rows of scan lines controls the first thin film transistors in all sub pixel circuits to be turned off, and an n+1th row of control lines inputs corresponding control signals to control the third thin film transistors in an n+1th row of sub pixel circuits to be turned on, and the control lines except the n+1th row of control lines input corresponding control signals to control the third thin film transistors in the sub pixel circuits except the n+1th row of sub pixel circuits to be turned off, and the plurality of columns of data lines inputs the bias voltages.

The present invention further provides a pixel driving circuit of an active matrix organic light emitting display device, comprising: a plurality of sub pixel circuits arranged in an array, a plurality of rows of scan lines, a plurality of columns of data lines and a plurality of rows of control lines;

wherein each row of sub pixel circuits is correspondingly coupled to one row of scan lines and one row of control lines, and each column of sub pixel circuits is correspondingly coupled to one column of data lines;

each sub pixel circuit comprises a first thin film transistor, a second thin film transistor, a third thin film transistor, a capacitor and an organic light emitting diode; a gate of the first thin film transistor is electrically coupled to a corresponding scan line, a source of the first thin film transistor is electrically to a corresponding data line, and a drain of the first thin film transistor is electrically to a gate of the second thin film transistor; a source of the second thin film transistor receives a power source positive voltage, and a drain of the second thin film transistor is electrically to an anode of the organic light emitting diode; two ends of the capacitor are respectively coupled to the gate and the source of the second thin film transistor; a cathode of the organic light emitting diode receives a power source negative voltage; a gate of the third thin film transistor is electrically to a corresponding control line, a source of the third thin film transistor is electrically to a corresponding data line, and a drain of the third thin film transistor is electrically to the anode of the organic light emitting diode;

in a blank display stage of each frame of the active matrix organic light emitting display device, the plurality of rows of control lines respectively input corresponding control signals to control the third thin film transistors in at least one row of sub pixel circuits to be turned on, and the plurality of columns of data lines inputs bias voltages, wherein the bias voltages are smaller than the power source negative voltage;

wherein the control signals inputted by the plurality of rows of control lines are pulse signals, and pulses of the control signals inputted by two adjacent control lines are sequentially generated, a phase difference between the pulses of the control signals inputted by the two adjacent control lines is one frame duration of the active matrix organic light emitting display device, a period of the control signal inputted by each control line is a product of the one frame duration of the active matrix organic light emitting display device and a number of rows of the sub pixel circuits;

in the blank display stage of each frame of the active matrix organic light emitting display device, the plurality of rows of control lines respectively input corresponding control signals to control the third thin film transistors in one row of sub pixel circuits to be turned on, and to control third thin film transistors in all sub pixel circuits except the row of sub pixel circuits to be turned off;

in an effective display stage of each frame of the active matrix organic light emitting display device, the plurality of rows of control lines respectively input corresponding control signals to control the third thin film transistors in all sub pixel circuits to be turned off;

wherein in a blank display stage of a (m×M+n)th frame of the active matrix organic light emitting display device, the plurality of rows of control lines respectively input corresponding control signals to control the third thin film transistors in a nth row of sub pixel circuits to be turned on, and to control third thin film transistors in sub pixel circuits except the nth row of sub pixel circuits to be turned off, wherein M is a number of rows of the sub pixel circuits, m is a non-negative integer and n is a positive integer;

wherein the third thin film transistor is an N-type thin film transistor;

wherein in an effective display stage of each frame of the active matrix organic light emitting display device, the plurality of rows of scan lines sequentially input scan signals to control the first thin film transistors in the plurality of rows of sub pixel circuits to be sequentially turned on, and the plurality of columns of data lines input corresponding data signals for the active matrix organic light emitting display device to show images.

The benefits of the present invention are: the pixel driving circuit of the AMOLED device provided by the present invention comprises: sub pixel circuits, scan lines, data lines and control lines. Each sub pixel circuit comprises a first TFT, a second TFT, a third TFT, a capacitor and an OLED. In a blank display stage of each frame of the AMOLED device, the plurality of rows of control lines respectively input corresponding control signals to control the third TFTs in at least one row of sub pixel circuits to be turned on, and the plurality of columns of data lines inputs bias voltages, wherein the bias voltages are smaller than the power source negative voltage so that an anode voltage of OLED in the sub pixel circuit, in which the third TFT is turned on, is smaller than a cathode voltage to achieve reverse bias. The aging of the OLED can be effectively reduced to prolong the life of the OLED and to improve display quality. The pixel driving method of the active matrix organic light emitting display device according to the present invention can effectively slow down the aging of organic light emitting diodes, extend the life of organic light emitting diodes and improve the display quality.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a circuit diagram of 2T1C pixel driving circuit employed for AMOLED according to prior art;

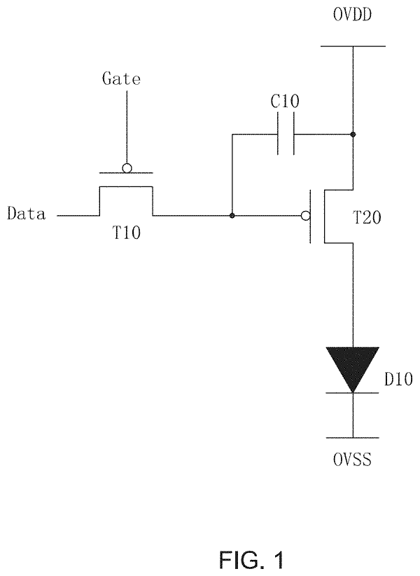

FIG. 2 is a circuit diagram of a pixel driving circuit of an active matrix organic light emitting display device according to the present invention.

FIG. 3 is a sequence diagram of a pixel driving circuit of an active matrix organic light emitting display device according to the present invention;

FIG. 4 is a flowchart of a pixel driving method of an active matrix organic light emitting display device according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

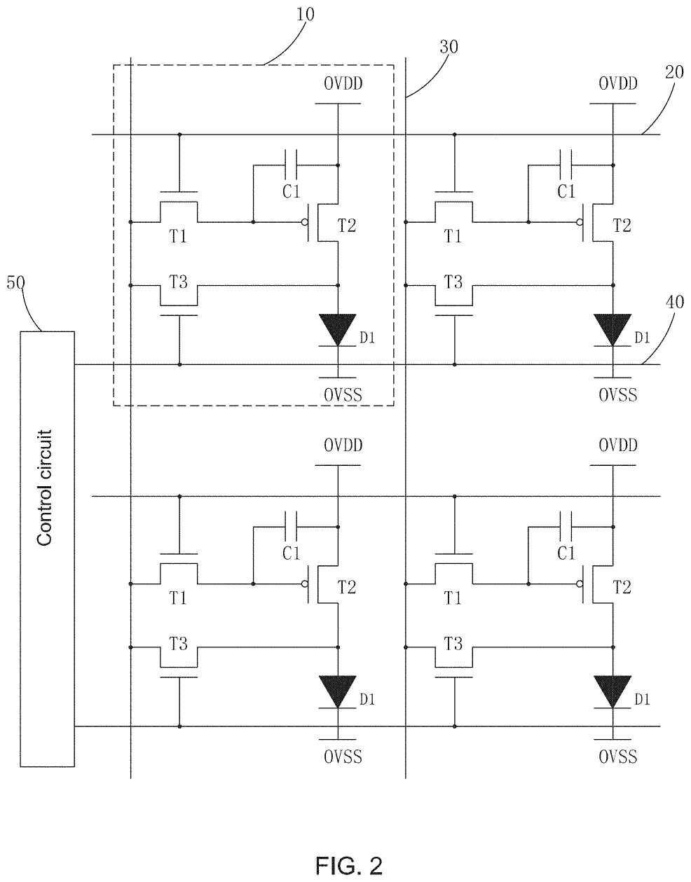

Please refer to FIG. 2. The present invention first provides a pixel driving circuit of an active matrix organic light emitting display device, comprising: a plurality of sub pixel circuits 10 arranged in an array, a plurality of rows of scan lines 20, a plurality of columns of data lines 30, a plurality of rows of control lines 40 and a control circuit 50.

Each row of sub pixel circuits 10 is correspondingly coupled to one row of scan lines 20 and one row of control lines 40, and each column of sub pixel circuits 10 is correspondingly coupled to one column of data lines 30, and the control circuit 50 is electrically coupled to the plurality of rows of control lines 40 to input control signals to the plurality of rows of control lines 40.

Each sub pixel circuit 10 comprises a first thin film transistor T1, a second thin film transistor T2, a third thin film transistor T3, a capacitor C1 and an organic light emitting diode D1; a gate of the first thin film transistor T1 is electrically coupled to a corresponding scan line 20, a source of the first thin film transistor is electrically to a corresponding data line 30, and a drain of the first thin film transistor is electrically to a gate of the second thin film transistor T2; a source of the second thin film transistor T2 receives a power source positive voltage OVDD, and a drain of the second thin film transistor is electrically to an anode of the organic light emitting diode D1; two ends of the capacitor C1 are respectively coupled to the gate and the source of the second thin film transistor T2; a cathode of the organic light emitting diode D1 receives a power source negative voltage OVSS; a gate of the third thin film transistor T3 is electrically to a corresponding control line 40, a source of the third thin film transistor is electrically to a corresponding data line 30, and a drain of the third thin film transistor is electrically to the anode of the organic light emitting diode D1.

Significantly, in a blank display stage of each frame of the active matrix organic light emitting display device, the plurality of rows of control lines 40 respectively input corresponding control signals to control the third thin film transistors T3 in at least one row of sub pixel circuits 10 to be turned on, and the plurality of columns of data lines 30 inputs bias voltages, wherein the bias voltages are smaller than the power source negative voltage OVSS.

Specifically, as shown in FIG. 2, the control signals inputted by the plurality of rows of control lines 40 are pulse signals, and pulses of the control signals inputted by two adjacent control lines 40 are sequentially generated, a phase difference between the pulses of the control signals inputted by the two adjacent control lines 40 is one frame duration of the active matrix organic light emitting display device, a period of the control signal inputted by each control line 40 is a product of the one frame duration of the active matrix organic light emitting display device and a number of rows of the sub pixel circuits 10. In a blank display stage of each frame of the active matrix organic light emitting display device, the plurality of rows of control lines 40 respectively input corresponding control signals to control the third thin film transistors T3 in one row of sub pixel circuits 10 to be turned on, and to control third thin film transistors T3 in all sub pixel circuits 10 except the row of sub pixel circuits 10 to be turned off. In an effective display stage of each frame of the active matrix organic light emitting display device, the plurality of rows of control lines 40 respectively input corresponding control signals to control the third thin film transistors T3 in all sub pixel circuits 10 to be turned off.

Preferably, in a blank display stage of a (m×M+n)th frame of the active matrix organic light emitting display device, the plurality of rows of control lines 40 respectively input corresponding control signals to control the third thin film transistors T3 in a nth row of sub pixel circuits 10 to be turned on, and to control third thin film transistors T3 in sub pixel circuits 10 except the nth row of sub pixel circuits 10 to be turned off, wherein M is a number of rows of the sub pixel circuits 10, m is a non-negative integer and n is a positive integer.

Specifically, the third thin film transistor T3 may be an N-type thin film transistor or a P-type thin film transistor. In the embodiment shown in FIG. 2, the third thin film transistor T3 is an N-type thin film transistor.

Specifically, in an effective display stage of each frame of the active matrix organic light emitting display device, the plurality of rows of scan lines 20 sequentially input scan signals to control the first thin film transistors T1 in the plurality of rows of sub pixel circuits 10 to be sequentially turned on, and the plurality of columns of data lines 30 input corresponding data signals for the active matrix organic light emitting display device to show images. In the blank display stage of each frame of the active matrix organic light emitting display device, the plurality of rows of scan lines 20 controls the first thin film transistors T1 in all sub pixel circuits 10 to be off.

Specifically, the first thin film transistor T1 may be an N-type thin film transistor and the second thin film transistor T2 may be a P-type thin film transistor.

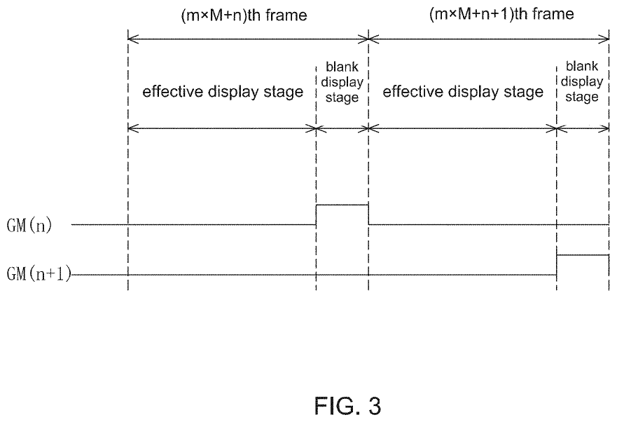

The embodiments shown in FIG. 2 and FIG. 3 are illustrated. The working process of the pixel driving circuit of the AMOLED display device of the present invention is described:

first, entering an effective display stage of a (m×M+n)th frame, wherein the plurality of rows of control lines 40 input control signals of low potential to control the third thin film transistors T3 in all sub pixel circuits 10 to be turned off, and the plurality of rows of scan lines 20 sequentially input scan signals of high potential to control the first thin film transistors T1 in the plurality of rows of sub pixel circuits 10 to be sequentially turned on, and the plurality of columns of data lines 30 input the data signals corresponding to the (m×M+n)th frame for the active matrix organic light emitting display device to normally show the (m×M+n)th frame.

Then, entering a blank display stage of the (m×M+n)th frame, wherein the plurality of rows of scan lines 20 controls the first thin film transistors T1 in all sub pixel circuits 10 to be turned off, and an nth row of control lines GM(n) inputs control signals of high potential to control the third thin film transistors T3 in an nth row of sub pixel circuits 10 to be turned on, and the control lines 40 except the nth row of control lines GM(n) input control signals of low potential to control the third thin film transistors T3 in the sub pixel circuits 10 except the nth row of sub pixel circuits 10 to be turned off, and the plurality of columns of data lines 30 inputs the bias voltages, and then the bias voltages lower than the power source negative voltage OVSS is written into the anodes of the organic light emitting diodes D1 in the nth row of sub pixel circuits 10 through the third thin film transistors T3, which are turned on, and the cathodes of the organic light emitting diodes D1 in the nth row of sub pixel circuits 10 receives the power source negative voltage OVSS. Namely, in the blank display stage of the (m×M+n)th frame, a voltage difference of the anode and the cathode of the organic light emitting diode D1 in the nth row of sub pixel circuits 10 is a negative value to be in a reverse bias state for reducing the aging of the organic light emitting diodes D1 in the nth row of sub pixel circuits 10.

After that, entering an effective display stage of a (m×M+n+1)th frame, wherein the plurality of rows of control lines 40 inputs control signals of low potential to control the third thin film transistors T3 in all sub pixel circuits 10 to be turned off, and the plurality of rows of scan lines 20 sequentially inputs scan signals of high potential to control the first thin film transistors T1 in the plurality of rows of sub pixel circuits 10 to be sequentially turned on, and the plurality of columns of data lines 30 inputs the data signals corresponding to the (m×M+n+1)th frame for the active matrix organic light emitting display device to normally show the (m×M+n+1)th frame.

Subsequently, entering a blank display stage of the (m×M+n+1)th frame, wherein the plurality of rows of scan lines 20 are at low potential and controls the first thin film transistors T1 in all sub pixel circuits 10 to be turned off, and an n+1th row of control lines GM(n+1) inputs control signals of high potential to control the third thin film transistors T3 in an n+1th row of sub pixel circuits 10 to be turned on, and the control lines 40 except the n+1th row of control lines GM(n+1) input control signals of low potential to control the third thin film transistors T3 in the sub pixel circuits 10 except the n+1th row of sub pixel circuits 10 to be turned off, and the plurality of columns of data lines 30 inputs the bias voltages, and then the bias voltages lower than the power source negative voltage OVSS is written into the anodes of the organic light emitting diodes D1 in the n+1th row of sub pixel circuits 10 through the third thin film transistors T3, which are turned on, and the cathodes of the organic light emitting diodes D1 in the n+1th row of sub pixel circuits 10 receives the power source negative voltage OVSS. Namely, in the blank display stage of the (m×M+n+)th frame, a voltage difference of the anode and the cathode of the organic light emitting diode D1 in the n+1th row of sub pixel circuits 10 is a negative value to be in a reverse bias state for reducing the aging of the organic light emitting diodes D1 in the n+1th row of sub pixel circuits 10.

After repeating the above steps, after a duration of M frames, the organic light emitting diodes D1 in the plurality of rows of sub pixel circuits 10 are all reverse biased once. In case that the number of rows of the sub pixel circuits 10 is 2160, and the refresh frequency is 60 Hz, i.e. the duration of one frame is 16.6 ms, the time interval between two reverse biases of the organic light emitting diodes D1 in the same row of sub pixel circuits 10 is 2160×16.6 ms=35.86 s.

Specifically, in the pixel driving circuit of the AMOLED device according to the present invention, by coupling the source to the corresponding data line 30, coupling the gate to the corresponding control line 40, and coupling the drain to the third thin film transistor T3 corresponding to the anode of the organic light emitting diode D1 in each sub pixel circuit 10, and by controlling the third thin film transistor T3 in at least one row of sub pixel circuits 10 to be turned on such that the bias voltage is written into the anode of the organic light emitting diode D1 to achieve the reverse bias thereof in the blank display stage of one frame of the AMOLED device, the aging of the OLED can be effectively reduced to prolong the life of the OLED and to improve display quality. Meanwhile, the present invention utilizes the data line 30 of inputting the data signal to implement writing the bias voltage to the anode of the organic light emitting diode D1 without adding additional voltage input line to simplify the structure of the AMOLED device and to promote the aperture ratio of the AMOLED device. Moreover, the bias voltage can be provided by a source driver chip of providing data signals. The number of source driver chips may be consistent with that of prior art, and the parasitic capacitance in the AMOLED may be effectively reduced.

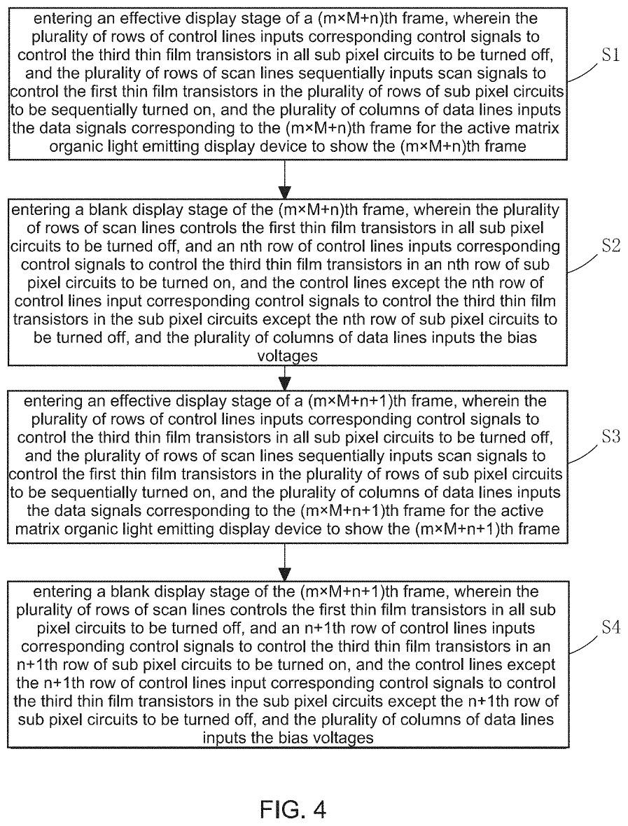

Please refer to FIG. 4, combined with FIG. 2 and FIG. 3. On the basis of the same inventive idea, the present invention further provides a pixel driving method of the active matrix organic light emitting display device, applied to the aforesaid pixel driving circuit of the active matrix organic light emitting display device, comprising:

Step S1, entering an effective display stage of a (m×M+n)th frame, wherein the plurality of rows of control lines 40 input corresponding control signals to control the third thin film transistors T3 in all sub pixel circuits 10 to be turned off, and the plurality of rows of scan lines 20 sequentially inputs scan signals to control the first thin film transistors T1 in the plurality of rows of sub pixel circuits 10 to be sequentially turned on, and the plurality of columns of data lines 30 inputs the data signals corresponding to the (m×M+n)th frame for the active matrix organic light emitting display device to show the (m×M+n)th frame, wherein M is a number of rows of the sub pixel circuit 10, m is a non-negative integer and n is a positive integer.

Specifically, in Step S1 of the embodiment shown in FIG. 2 and FIG. 3, the plurality of rows of control lines 40 input control signals of low potential to control the third thin film transistors T3 in all sub pixel circuits 10 to be turned off, and the plurality of rows of scan lines 20 sequentially input scan signals of high potential to control the first thin film transistors T1 in the plurality of rows of sub pixel circuits 10 to be sequentially turned on, and the plurality of columns of data lines 30 input the data signals corresponding to the (m×M+n)th frame for the active matrix organic light emitting display device to normally show the (m×M+n)th frame.

Step S2, entering a blank display stage of the (m×M+n)th frame, wherein the plurality of rows of scan lines 20 controls the first thin film transistors T1 in all sub pixel circuits 20 to be turned off, and an nth row of control lines GM(n) inputs corresponding control signals to control the third thin film transistors T3 in an nth row of sub pixel circuits 10 to be turned on, and the control lines 40 except the nth row of control lines GM(n) input corresponding control signals to control the third thin film transistors T3 in the sub pixel circuits 10 except the nth row of sub pixel circuits 10 to be turned off, and the plurality of columns of data lines 30 inputs the bias voltages.

Specifically, in Step S2 of the embodiment shown in FIG. 2 and FIG. 3, the plurality of rows of scan lines 20 controls the first thin film transistors T1 in all sub pixel circuits 10 to be turned off, and an nth row of control lines GM(n) inputs control signals of high potential to control the third thin film transistors T3 in an nth row of sub pixel circuits 10 to be turned on, and the control lines 40 except the nth row of control lines GM(n) input control signals of low potential to control the third thin film transistors T3 in the sub pixel circuits 10 except the nth row of sub pixel circuits 10 to be turned off, and the plurality of columns of data lines 30 inputs the bias voltages, and then the bias voltages lower than the power source negative voltage OVSS is written into the anodes of the organic light emitting diodes D1 in the nth row of sub pixel circuits 10 through the third thin film transistors T3, which are turned on, and the cathodes of the organic light emitting diodes D1 in the nth row of sub pixel circuits 10 receives the power source negative voltage OVSS. Namely, in the blank display stage of the (m×M+n)th frame, a voltage difference of the anode and the cathode of the organic light emitting diode D1 in the nth row of sub pixel circuits 10 is a negative value to be in a reverse bias state for reducing the aging of the organic light emitting diodes D1 in the nth row of sub pixel circuits 10.

Step S3, entering an effective display stage of a (m×M+n+1)th frame, wherein the plurality of rows of control lines 40 inputs corresponding control signals to control the third thin film transistors T3 in all sub pixel circuits 10 to be turned off, and the plurality of rows of scan lines 20 sequentially inputs scan signals to control the first thin film transistors T1 in the plurality of rows of sub pixel circuits 10 to be sequentially turned on, and the plurality of columns of data lines 30 inputs the data signals corresponding to the (m×M+n+1)th frame for the active matrix organic light emitting display device to show the (m×M+n+1)th frame.

Specifically, in Step S3 of the embodiment shown in FIG. 2 and FIG. 3, the plurality of rows of control lines 40 inputs control signals of low potential to control the third thin film transistors T3 in all sub pixel circuits 10 to be turned off, and the plurality of rows of scan lines 20 sequentially inputs scan signals of high potential to control the first thin film transistors T1 in the plurality of rows of sub pixel circuits 10 to be sequentially turned on, and the plurality of columns of data lines 30 inputs the data signals corresponding to the (m×M+n+1)th frame for the active matrix organic light emitting display device to normally show the (m×M+n+1)th frame.

Step S4, entering a blank display stage of the (m×M+n+1)th frame, wherein the plurality of rows of scan lines 20 controls the first thin film transistors T1 in all sub pixel circuits 10 to be turned off, and an n+1th row of control lines GM(n+1) inputs corresponding control signals to control the third thin film transistors T3 in an n+1th row of sub pixel circuits 10 to be turned on, and the control lines 40 except the n+1th row of control lines GM(n+1) input corresponding control signals to control the third thin film transistors T3 in the sub pixel circuits 10 except the n+1th row of sub pixel circuits 10 to be turned off, and the plurality of columns of data lines 30 inputs the bias voltages.

Specifically, in Step S4 of the embodiment shown in FIG. 2 and FIG. 3, the plurality of rows of scan lines 20 are at low potential and controls the first thin film transistors T1 in all sub pixel circuits 10 to be turned off, and an n+1th row of control lines GM(n+1) inputs control signals of high potential to control the third thin film transistors T3 in an n+1th row of sub pixel circuits 10 to be turned on, and the control lines 40 except the n+1th row of control lines GM(n+1) input control signals of low potential to control the third thin film transistors T3 in the sub pixel circuits 10 except the n+1th row of sub pixel circuits 10 to be turned off, and the plurality of columns of data lines 30 inputs the bias voltages, and then the bias voltages lower than the power source negative voltage OVSS is written into the anodes of the organic light emitting diodes D1 in the n+1th row of sub pixel circuits 10 through the third thin film transistors T3, which are turned on, and the cathodes of the organic light emitting diodes D1 in the n+1th row of sub pixel circuits 10 receives the power source negative voltage OVSS. Namely, in the blank display stage of the (m×M+n+1)th frame, a voltage difference of the anode and the cathode of the organic light emitting diode D1 in the n+1th row of sub pixel circuits 10 is a negative value to be in a reverse bias state for reducing the aging of the organic light emitting diodes D1 in the n+1th row of sub pixel circuits 10.

After repeating the above steps, after a duration of M frames, the organic light emitting diodes D1 in the plurality of rows of sub pixel circuits 10 are all reverse biased once. In case that the number of rows of the sub pixel circuits 10 is 2160, and the refresh frequency is 60 Hz, i.e. the duration of one frame is 16.6 ms, the time interval between two reverse biases of the organic light emitting diodes D1 in the same row of sub pixel circuits 10 is 2160×16.6 ms=35.86 s.

Specifically, in the pixel driving method of the AMOLED device according to the present invention, by coupling the source to the corresponding data line 30, coupling the gate to the corresponding control line 40, and coupling the drain to the third thin film transistor T3 corresponding to the anode of the organic light emitting diode D1 in each sub pixel circuit 10, and by controlling the third thin film transistor T3 in at least one row of sub pixel circuits 10 to be turned on such that the bias voltage is written into the anode of the organic light emitting diode D1 to achieve the reverse bias thereof in the blank display stage of one frame of the AMOLED device, the aging of the OLED can be effectively reduced to prolong the life of the OLED and to improve display quality. Meanwhile, the present invention utilizes the data line 30 of inputting the data signal to implement writing the bias voltage to the anode of the organic light emitting diode D1 without adding additional voltage input line to simplify the structure of the AMOLED device and to promote the aperture ratio of the AMOLED device. Moreover, the bias voltage can be provided by a source driver chip of providing data signals. The number of source driver chips may be consistent with that of prior art, and the parasitic capacitance in the AMOLED may be effectively reduced.

In conclusion, the pixel driving circuit of the AMOLED device provided by the present invention comprises: sub pixel circuits, scan lines, data lines and control lines. Each sub pixel circuit comprises a first TFT, a second TFT, a third TFT, a capacitor and an OLED. In a blank display stage of each frame of the AMOLED device, the plurality of rows of control lines respectively input corresponding control signals to control the third TFTs in at least one row of sub pixel circuits to be turned on, and the plurality of columns of data lines inputs bias voltages, wherein the bias voltages are smaller than the power source negative voltage so that an anode voltage of OLED in the sub pixel circuit, in which the third TFT is turned on, is smaller than a cathode voltage to achieve reverse bias. The aging of the OLED can be effectively reduced to prolong the life of the OLED and to improve display quality. The pixel driving method of the active matrix organic light emitting display device according to the present invention can effectively slow down the aging of organic light emitting diodes, extend the life of organic light emitting diodes and improve the display quality.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A pixel driving circuit of an active matrix organic light emitting display device, comprising: a plurality of sub pixel circuits arranged in an array, a plurality of rows of scan lines, a plurality of columns of data lines and a plurality of rows of control lines;
wherein each row of sub pixel circuits is correspondingly coupled to one row of scan lines and one row of control lines, and each column of sub pixel circuits is correspondingly coupled to one column of data lines;
each sub pixel circuit comprises a first thin film transistor, a second thin film transistor, a third thin film transistor, a capacitor and an organic light emitting diode; a gate of the first thin film transistor is electrically coupled to a corresponding scan line, a source of the first thin film transistor is electrically to a corresponding data line, and a drain of the first thin film transistor is electrically to a gate of the second thin film transistor; a source of the second thin film transistor receives a power source positive voltage, and a drain of the second thin film transistor is electrically to an anode of the organic light emitting diode; two ends of the capacitor are respectively coupled to the gate and the source of the second thin film transistor; a cathode of the organic light emitting diode receives a power source negative voltage; a gate of the third thin film transistor is electrically to a corresponding control line, a source of the third thin film transistor is electrically to a corresponding data line, and a drain of the third thin film transistor is electrically to the anode of the organic light emitting diode;
in a blank display stage of each frame of the active matrix organic light emitting display device, the plurality of rows of control lines respectively input corresponding control signals to control the third thin film transistors in at least one row of sub pixel circuits to be turned on, and the plurality of columns of data lines inputs bias voltages, wherein the bias voltages are smaller than the power source negative voltage.

2. The pixel driving circuit of the active matrix organic light emitting display device according to claim 1, wherein the control signals inputted by the plurality of rows of control lines are pulse signals, and pulses of the control signals inputted by two adjacent control lines are sequentially generated, a phase difference between the pulses of the control signals inputted by the two adjacent control lines is one frame duration of the active matrix organic light emitting display device, a period of the control signal inputted by each control line is a product of the one frame duration of the active matrix organic light emitting display device and a number of rows of the sub pixel circuits;
in the blank display stage of each frame of the active matrix organic light emitting display device, the plurality of rows of control lines respectively input corresponding control signals to control the third thin film transistors in one row of sub pixel circuits to be turned on, and to control third thin film transistors in all sub pixel circuits except the row of sub pixel circuits to be turned off;
in an effective display stage of each frame of the active matrix organic light emitting display device, the plurality of rows of control lines respectively input corresponding control signals to control the third thin film transistors in all sub pixel circuits to be turned off.

3. The pixel driving circuit of the active matrix organic light emitting display device according to claim 2, wherein in a blank display stage of a (m×M+n)th frame of the active matrix organic light emitting display device, the plurality of rows of control lines respectively input corresponding control signals to control the third thin film transistors in a nth row of sub pixel circuits to be turned on, and to control third thin film transistors in sub pixel circuits except the nth row of sub pixel circuits to be turned off, wherein M is a number of rows of the sub pixel circuits, m is a non-negative integer and n is a positive integer.

4. The pixel driving circuit of the active matrix organic light emitting display device according to claim 2, wherein the third thin film transistor is an N-type thin film transistor.

5. The pixel driving circuit of the active matrix organic light emitting display device according to claim 1, wherein in an effective display stage of each frame of the active matrix organic light emitting display device, the plurality of rows of scan lines sequentially input scan signals to control the first thin film transistors in the plurality of rows of sub pixel circuits to be sequentially turned on, and the plurality of columns of data lines input corresponding data signals for the active matrix organic light emitting display device to show images.

6. The pixel driving circuit of the active matrix organic light emitting display device according to claim 1, wherein in the blank display stage of each frame of the active matrix organic light emitting display device, the plurality of rows of scan lines controls the first thin film transistors in all sub pixel circuits to be off.

7. The pixel driving circuit of the active matrix organic light emitting display device according to claim 1, wherein the first thin film transistor is an N-type thin film transistor, and the second thin film transistor is a P-type thin film transistor.

8. The pixel driving circuit of the active matrix organic light emitting display device according to claim 1, further comprising a control circuit electrically coupled to the plurality of rows of control lines, and the control signals inputted to the plurality of rows of control lines are provided by the control circuit.

9. A pixel driving method of the active matrix organic light emitting display device, applied to the pixel driving circuit of the active matrix organic light emitting display device according to claim 1, comprising:
Step S1, entering an effective display stage of a (m×M+n)th frame, wherein the plurality of rows of control lines inputs corresponding control signals to control the third thin film transistors in all sub pixel circuits to be turned off, and the plurality of rows of scan lines sequentially inputs scan signals to control the first thin film transistors in the plurality of rows of sub pixel circuits to be sequentially turned on, and the plurality of columns of data lines inputs the data signals corresponding to the (m×M+n)th frame for the active matrix organic light emitting display device to show the (m×M+n)th frame, wherein M is a number of rows of the sub pixel circuit, m is a non-negative integer and n is a positive integer;
Step S2, entering a blank display stage of the (m×M+n)th frame, wherein the plurality of rows of scan lines controls the first thin film transistors in all sub pixel circuits to be turned off, and an nth row of control lines inputs corresponding control signals to control the third thin film transistors in an nth row of sub pixel circuits to be turned on, and the control lines except the nth row of control lines input corresponding control signals to control the third thin film transistors in the sub pixel circuits except the nth row of sub pixel circuits to be turned off, and the plurality of columns of data lines inputs the bias voltages;
Step S3, entering an effective display stage of a (m×M+n+1)th frame, wherein the plurality of rows of control lines inputs corresponding control signals to control the third thin film transistors in all sub pixel circuits to be turned off, and the plurality of rows of scan lines sequentially inputs scan signals to control the first thin film transistors in the plurality of rows of sub pixel circuits to be sequentially turned on, and the plurality of columns of data lines inputs the data signals corresponding to the (m×M+n+1)th frame for the active matrix organic light emitting display device to show the (m×M+n+1)th frame;
Step S4, entering a blank display stage of the (m×M+n+1)th frame, wherein the plurality of rows of scan lines controls the first thin film transistors in all sub pixel circuits to be turned off, and an n+1th row of control lines inputs corresponding control signals to control the third thin film transistors in an n+1th row of sub pixel circuits to be turned on, and the control lines except the n+1th row of control lines input corresponding control signals to control the third thin film transistors in the sub pixel circuits except the n+1th row of sub pixel circuits to be turned off, and the plurality of columns of data lines inputs the bias voltages.

10. A pixel driving circuit of an active matrix organic light emitting display device, comprising: a plurality of sub pixel circuits arranged in an array, a plurality of rows of scan lines, a plurality of columns of data lines and a plurality of rows of control lines;
wherein each row of sub pixel circuits is correspondingly coupled to one row of scan lines and one row of control lines, and each column of sub pixel circuits is correspondingly coupled to one column of data lines;
each sub pixel circuit comprises a first thin film transistor, a second thin film transistor, a third thin film transistor, a capacitor and an organic light emitting diode; a gate of the first thin film transistor is electrically coupled to a corresponding scan line, a source of the first thin film transistor is electrically to a corresponding data line, and a drain of the first thin film transistor is electrically to a gate of the second thin film transistor; a source of the second thin film transistor receives a power source positive voltage, and a drain of the second thin film transistor is electrically to an anode of the organic light emitting diode: two ends of the capacitor are respectively coupled to the gate and the source of the second thin film transistor; a cathode of the organic light emitting diode receives a power source negative voltage; a gate of the third thin film transistor is electrically to a corresponding control line, a source of the third thin film transistor is electrically to a corresponding data line, and a drain of the third thin film transistor is electrically to the anode of the organic light emitting diode;
in a blank display stage of each frame of the active matrix organic light emitting display device, the plurality of rows of control lines respectively input corresponding control signals to control the third thin film transistors in at least one row of sub pixel circuits to be turned on, and the plurality of columns of data lines inputs bias voltages, wherein the bias voltages are smaller than the power source negative voltage;
wherein the control signals inputted by the plurality of rows of control lines are pulse signals, and pulses of the control signals inputted by two adjacent control lines are sequentially generated, a phase difference between the pulses of the control signals inputted by the two adjacent control lines is one frame duration of the active matrix organic light emitting display device, a period of the control signal inputted by each control line is a product of the one frame duration of the active matrix organic light emitting display device and a number of rows of the sub pixel circuits;
in the blank display stage of each frame of the active matrix organic light emitting display device, the plurality of rows of control lines respectively input corresponding control signals to control the third thin film transistors in one row of sub pixel circuits to be turned on, and to control third thin film transistors in all sub pixel circuits except the row of sub pixel circuits to be turned off;
in an effective display stage of each frame of the active matrix organic light emitting display device, the plurality of rows of control lines respectively input corresponding control signals to control the third thin film transistors in all sub pixel circuits to be turned off;
wherein in a blank display stage of a (m×M+n)th frame of the active matrix organic light emitting display device, the plurality of rows of control lines respectively input corresponding control signals to control the third thin film transistors in a nth row of sub pixel circuits to be turned on, and to control third thin film transistors in sub pixel circuits except the nth row of sub pixel circuits to be turned off, wherein M is a number of rows of the sub pixel circuits, m is a non-negative integer and n is a positive integer;
wherein the third thin film transistor is an N-type thin film transistor;
wherein in an effective display stage of each frame of the active matrix organic light emitting display device, the plurality of rows of scan lines sequentially input scan signals to control the first thin film transistors in the plurality of rows of sub pixel circuits to be sequentially turned on, and the plurality of columns of data lines input corresponding data signals for the active matrix organic light emitting display device to show images.

11. The pixel driving circuit of the active matrix organic light emitting display device according to claim 10, wherein in the blank display stage of each frame of the active matrix organic light emitting display device, the plurality of rows of scan lines controls the first thin film transistors in all sub pixel circuits to be off.

12. The pixel driving circuit of the active matrix organic light emitting display device according to claim 10, wherein the first thin film transistor is an N-type thin film transistor, and the second thin film transistor is a P-type thin film transistor.

13. The pixel driving circuit of the active matrix organic light emitting display device according to claim 10, further comprising a control circuit electrically coupled to the plurality of rows of control lines, and the control signals inputted to the plurality of rows of control lines are provided by the control circuit.
